(19) United States
(12) Patent Application Publication
(10) Pub. No.: US 2019/0133368 A1
(43) Pub. Date: May 9, 2019

(54) FROTHING DEVICE, ASSEMBLY FOR FROTHING AND METHOD OF USE OF THE DEVICE

(71) Applicant: Tjeerd Pieter SCHRAVENDEEL, Amsterdam (NL)

(72) Inventor: Tjeerd Pieter SCHRAVENDEEL, Amsterdam (NL)

(21) Appl. No.: 16/095,325

(22) PCT Filed: Apr. 14, 2017
(86) PCT No.: PCT/NL2017/050238

§ 371 Date: Oct. 19, 2018

(30) Foreign Application Priority Data
Apr. 21, 2016 (NL) N1041833
Nov. 28, 2016 (NL) N2017878

(51) Int. Cl. A47J 31/44

(52) U.S. Cl. CPC A47J 31/4489

(57) ABSTRACT

Frothing milk for cappuccinos is a skill that not many of the employees of restaurants and café s poses. Cappuccinos are therefore not always as creamy as preferred by the customers. The invention provides a device for frothing a liquid. This device allows employees of restaurants and café s with a minimum of skill and training to froth milk for much appreciated cappuccinos. The device comprises a support for positioning the device on a receptacle holding the liquid; and a guide for guiding an outlet for expelling a fluid for frothing the liquid, wherein the guide is adapted for positioning the outlet at an angle and/or a depth inside the receptacle relative to the support.

### FIELD OF THE INVENTION

The invention relates to the field of frothing devices, assemblies for frothing and method of use of these devices.

### BACKGROUND OF THE INVENTION

Frothing milk for cappuccinos is a skill that not many of the employees of restaurants and café s poses. Frothing milk for cappuccinos requires talent and training before a creamy substance or milk froth or foam is produced for creating a cappuccino, which may deserve the appreciation of the customer.

A typical coffee machine in a restaurant or café has a steam pipe for frothing milk. The operator of the coffee machine, such as a barista, places the end of the steam pipe in a milk can. Thereafter the operator lets the steam flow for frothing the milk. Hereby the steam gradually mixes with the milk creating a creamy milk froth, if done skillfully.

To develop the skill of frothing milk, a training should be followed. Learning on the job is a less preferred alternative, because the cappuccinos served during the learning period will be of less quality. Combined with the fact that a job in a restaurant is often seen as a side-job, were employee turn-over is high, a clear need for shortening the training period for frothing milk and lowering the amount of talent and/or skill needed for learning to froth milk is needed.

### SUMMARY OF THE INVENTION

An object of the invention is to provide a device and method of use of the device for frothing a liquid, such as milk.

For this purpose, according to a first aspect of the invention, an auxiliary device for frothing a liquid in a receptacle, comprising: a support for positioning the device on the receptacle holding the liquid; and a guide for positioning an outlet for expelling a fluid for frothing the liquid, wherein the guide is adapted for positioning the outlet at an angle and/or a depth inside the receptacle relative to the support for letting the fluid create a jetstream in the liquid.

Frothing a liquid requires the positioning of the outlet expelling a fluid under an angle and at a certain depth below the liquid level in the receptacle. If the outlet expels a fluid, when positioned, then the fluid creates a jetstream, comparable to a speedboat, in the liquid. The jetstream mixes the fluid and the liquid. To create a homogenous foam of gas pockets of comparable small sizes, a foam effect is needed. This type of foam is known as a micro-foam. The foam effect is the effect of a jetstream, placed in a liquid at a depth, causing air to rush along the outlet, preferably the guide, and mix with the liquid to create these small gas pockets of predominantly the same size. If the outlet is positioned too shallow, the jetstream will cause too much gas, such as air, to rush along the outlet, preferably the guide, and mix with the liquid to create larger gas pockets having a larger variation in size compared to the smaller gas pockets, as mentioned before. And if the outlet is positioned even more shallow or above the liquid, the jetstream will cause the liquid to move away from the jetstream without causing gas to mix with the liquid. If the outlet is positioned too deep, the liquid will close above the jetstream and no gas apart from the gas in the fluid will be introduced in the liquid. This will cause the foam to be inferior or even absent. By positioning the outlet at a certain depth, as described above, in the liquid the foam effect can be optimized to create a homogenous foam of small air pockets of reasonable comparable size.

To create a foam throughout the receptacle, a mixing effect is needed. The mixing effect is the effect of a jetstream, placed in a liquid at the right angle and position, causing a swirl within the receptacle for mixing the foam with the liquid. This effect causes liquid to pass along the jetstream for creating foam. If the outlet is positioned under a too sharp angle with the liquid, predominantly a horizontal segment, such as a cylindrically shaped segment or a top part, of the liquid will be mixed and thus frothed. This situation may also be recognized from the effect that the expelled fluid rushes over the liquid, instead of into the liquid creating the jetstream. And if the outlet is positioned under a too obtuse angle with the liquid, predominantly only a vertical segment, such as a pie part shaped segment, of the liquid will be mixed and thus frothed. And even if a swirl will occur, this swirl will have a slow rotation, causing an insufficient mixing effect. And if the outlet is positioned too much to the centre of a receptacle, such as a centre of a cylindrically shaped receptacle, the jetstream will cause a slow rotating swirl causing an insufficient mixing effect. And if the outlet is positioned too close to a side wall of a receptacle, such as a side wall of a cylindrically shaped receptacle, the jetstream will interact with the side wall damping the effect of the jetstream, also hampering a mixing effect. By positioning the outlet under a certain angle and position in the liquid the mixing effect can be optimized to create an equally distributed foam.

A fluid, such as a foam, or liquid in a receptacle has a level, which is the top of the fluid or liquid. A support of a device for frothing may be placed upon the receptacle thereby placing the support at a certain distance from the level. An in position guided outlet expels the fluid at a position relative to the support. Due to the certain distance and the predefined distance between the support and the in position guided outlet, the depth of the expelled fluid relative to the level is defined. Further, the support placed upon the receptacle fixes the direction of the guide. Also, an expelled fluid from an outlet has a flow direction relative to the outlet. The in position guided outlet provides a predefined angle between the guide and the expelled fluid and thus indirectly defines the angle between the level and the expelled fluid. Hence, a guide of the device is adapted to position an outlet for having the expelled fluid being expelled at an angle and/or a depth inside the receptacle relative to the level.

Although frothing requires the positioning of the outlet under an angle with and at a depth relative to the level, a device positioning the outlet for one of these parameters already reaches the objective of the invention. A device only positioning the outlet for one parameter allows the operator to concentrate on the other parameter, thereby shortening the training period and thus reaching the objective of the invention.

The angle with the level is typically in the range of 55-89 degrees, preferably 65-85 degrees, more preferably 70-82 degrees, most preferably around 80 degrees. The depth of the outlet relative to the level is typically 0.5-20 mm, preferably 0.7-15 mm, more preferably 0.9-10 mm, most preferably 1-5 mm.

For frothing, next to the angle and depth of the outlet, the pressure of the expelled fluid is a parameter to consider. Depending on the pressure of the expelled fluid, the angle and/or depth may differ. The pressure of the expelled fluid is typically in the range of 0.2-8 bar, preferably 0.2-5 bar, more preferably 0.3-3 bar, most preferably 1.4 bar.

Apart from the ranges for the angle, the depth and the pressure, given above, the support should provide a stable platform for the guide for stably positioning the outlet inside the receptacle during frothing. The range variation is typically within the range of 6 degrees, preferably 4 degrees, more preferably 1 degrees, most preferably 0.5 degrees. The depth variation is typically within the range of 7 mm, preferably 4 mm, more preferably 1 mm, most preferably 0.5 mm. The pressure variation is typically 0.6 bar, preferably 0.4 bar, more preferably 0.2 bar, most preferably 0.1 bar.

An air pocket in a foam is typically spherically shaped. The air pocket may be characterized by the diameter of the air pocket. A homogeneity of a foam may be expressed in the variation of diameters of air pockets forming the foam. A micro-foam, which is a homogenous foam, contains predominantly air pockets having a diameter in the range of 0.1 mm-2.5 mm, preferably 0.2-2 mm, more preferably 0.3-1.5 mm. An inhomogeneous foam contains predominantly air pockets having a diameter larger than 3 mm, preferably larger than 3.5 mm, more preferably larger than 4 mm, wherein the diameters of the bulk of air pockets are spread over a range of more than 3 mm, preferably more than 4 mm, more preferably more than 10 mm, most preferably more than 15 mm or more.

The stability of a foam may be a measure for the time it takes for surplus fluid mixed with the foam to separate in gas bubbles and liquid. The stability of a foam may also be a measure for the time it takes for a part of the air bubbles in the foam to burst. The stability of the foam may be a combination of the previously defined measures.

In an embodiment of the device, the angle and/or the depth may be adapted before frothing. This provides the advantage of adapting the device for at least one of the group of differently sized receptacles, liquid levels, liquid types, fluid types and pressures of expelled fluid.

In an embodiment of the device, the angle and/or the depth is predefined. This provides a simple device with the advantage that a not skilled person, able to froth a liquid, is required to set the angle and depth correctly before the training period may commence, thus shortening the training period.

In an embodiment of the device, the support comprises a coupling for releasable coupling to the receptacle. When frothing with the use of the device, the operator should keep the receptacle in position with one or more fingers or one hand, and operate the valve controlling the flow of the fluid expelled from the outlet with the other hand. By advantageously coupling the device to the receptacle, a shift or rotation of the device relative to the receptacle during frothing is prevented, e.g. when the operator releases or loosens its grip on the device for a moment for operating the valve. This advantage will ease the handling of the operator, thereby shortening the training period.

In an embodiment of the device, the support comprises a recess for receiving a part of the receptacle for positioning the device. The recess advantageously restrains the device to provide an improved stability when the support is positioned. This advantage will ease the handling of the operator, thereby shortening the training period.

In an embodiment of the device, the device comprises a recess comprising two walls having an arced shape having distinct centres and wherein at least one of the walls is resilient, for forming the coupling. The distinct centres of the arced shaped walls cause the width of the recess to vary over its length. The effect of this recess is that the receptacle may be gripped by this recess. Typically, a receptacle comprises a cylindrically shaped side wall of a predefined thickness having a rim. The predefined thickness is typically constant along the circumference of the side wall of the receptacle. The width of the recess at its narrowest point should be narrower than the thickness of the side wall. The combination of this narrowest point combined with at least one of the walls of the recess being resilient provides the effect of the support clamping the receptacle, preferably a side wall of the receptacle, for providing a stable position for the support. This advantage will ease the handling of the operator, thereby shortening the training period.

In a further embodiment of the device, the width of the recess at its widest point is broader than the thickness of the side wall. As a result, the recess will not provide a clamping effect over the complete length of the recess. This provides the advantages of reduced friction when placing on or removing the support from a receptacle. This advantage will ease the handling of the operator, thereby shortening the training period.

In a further embodiment of the device, the widest point is flanked on both sides with narrower points, wherein the narrower points provide a width narrower than the thickness of the side wall. This provides at least two clamping points placed at a distance. The effect of the at least two clamping points placed at a distance is that the stability of the support when placed on the receptacle is improved, while reducing the friction when placing the support on or removing the support from the receptacle.

In an embodiment of the device, the recess has a cross sectional shape of a ‘U’, wherein one leg of the ‘U’ is longer relative to the other leg. The receptacle typically has a side wall providing a rim. The recess needs to be aligned with the side wall, before the recess receives the side wall for positioning the device. Typically, the alignment is done by an operator while the receptacle is placed below his eye level and the opening of the recess faces downward, away from the operators view. The longer leg advantageously allows to tactilely align the recess with the rim.

In an embodiment of the device, the guide has an elongated hollow body comprising an abutment on one end for receiving the outlet in the elongated hollow body and for abutting the outlet on the abutment for positioning the outlet at the angle and/or the depth inside the receptacle relative to the support. An abutment is an advantageous implementation for positioning the outlet. Typically, a conduit having an outlet on one end is used for expelling the fluid. A guide having an elongated hollow body provides the advantage of a longer trajectory along which the conduit is guided. Examples of an elongated hollow body are a tubular body, a hollow bar and a hollow triangular prism. The guide may for example also be a half-pipe.

In a further embodiment of the device, the guide has a level indicator for indicating a preferred filling level of the fluid. Typically, the liquid is poured in the receptacle after the support of the device is placed on the receptacle. To allow the operator to pour the correct amount of liquid in the receptacle for thereafter expelling a fluid from the positioned outlet at the correct depth relative to the level of the fluid, the level indicator provides a simplified method of pouring this right amount. In an embodiment, the level indicator is a groove, protuberance or line around the circumference of the guide or the elongated hollow body. In an embodiment, the guide or the elongated hollow body comprises multiple level indicators for allowing the level to be adapted preferably depending on at least one of the group of type of liquid, type of fluid, pressure of the expelled fluid, size of the receptacle and setting of the angle and/or distance between the support and the guide. In a further embodiment, the guide or the elongated hollow body comprises multiple grooves around the circumference of the guide or the elongated hollow body for indicating different levels, wherein a resilient clip or ring, such as a rubber ring, placed in one of the grooves, selects the preferred level indicator. In an embodiment of the resilient clip or ring, the clip or ring comprises a protrusion. The protrusion may be used for improving ease of grabbing the clip or ring by a hand for moving the clip or ring from one groove to another, respectively. Alternatively, the protrusion may be used to indicate a level distinct from a level indicated by the groove in which the clip or ring is positioned, preferably a level lower than the groove wherein the clip or ring is positioned. Hence, the protrusion provides the advantage of an indication for a level below the level indicatable by the lowest groove and/or a sub-level between two adjacent grooves.

In an embodiment of the device, the support and the guide are connectable and are made of a mouldable material, wherein the support comprises a recess having an opening, wherein a direction perpendicular to the opening defines a first direction and wherein the guide comprises a hollow elongated body having a longitudinal axis defining a second direction. Typically, the first and second direction make an angle different from zero. If the support and guide are integrally made out of plastic with the use of a mould or matrix, the device will not be self-unloading from the mould. By advantageously moulding the support and the guide as separate parts the manufacturing is simplified by the self-unloading characteristics of the parts of the device.

In an embodiment of the device, the support and the guide are releasable connectable. This feature allows improved and simplified cleaning. In a further embodiment of the device, the support and the guide are releasable connectable under different angles and/or at different distances. This feature advantageously allows to adapt the device to at least one of the group of type of liquid, type of fluid, pressure of the expelled fluid and size of the receptacle.

In an embodiment of the device, the device comprises a temperature indicator for indicating a temperature inside the receptacle of the liquid or the frothed liquid. Typically, the expelled fluid has a temperature different from the liquid. The temperature indicator advantageously allows the operator to monitor the temperature of the liquid or the frothed liquid and to stop expelling the fluid if the temperature of the frothed liquid reaches a predefined temperature.

In an embodiment of the device, the device is suitable for frothing a liquid containing protein, such as milk, and/or the guide is suitable for positioning an outlet expelling steam as a fluid. Milk is normally stored at a temperature around 5 degrees Celsius. Steam from a coffee machine is at least 100 degrees Celsius. Hence, frothing milk with steam heats the milk. Further, experiments show that milk will turn into foam below 40 degrees by creating small air pockets of comparable size in the milk. This type of small air pockets does not vary much in size and are therefore considered homogenous. The resulting foam will have a creamy flavour and be stable and homogenous. Further, experiments show that milk will turn into foam above 40 degrees by creating larger air pockets of varying sizes. This type of air pockets may be less stable and vary much more in size than the smaller air pockets. The resulting foam with the larger air pockets will have a rigidly tasting flavour and may be less stable and is inhomogeneous. Therefore, above 40 degrees the steam, causing a jetstream, substantially mixes the earlier created small gas pockets with the liquid for creating a creamy homogenous foam at an increasing temperature. Furthermore, it is known that protein molecules in milk start to disintegrate at a temperature above 68 degrees Celsius. A milk based coffee requires milk to be frothed to foam of the homogenous type having small air pockets to a temperature around 65 degrees Celsius. This allows a milk based coffee, such as a cappuccino, latte or latte macchiato etc., to be served that is longer preserving its quality. The device is adapted to allow an operator with a minimal effort and training to turn the milk into a homogenous foam before the temperature of the milk reaches about 40 degrees Celsius. Furthermore, the device allows the foam to be continuously mixed while heating the foam to around 65 degrees Celsius, so a homogeneous mixture or foam of liquid and gas forms.

As described above, the process of frothing may be subdivided in two phases. The first phase were the milk is frothed below 40 degrees and the second phase were the milk is frothed above 40 degrees. In both phases the jetstream caused by the expelled steam is present.

In the first phase, the jetstream causes air to be mixed into the milk as the outlet is at a depth below the liquid level to allow the jetstream to draw air from above the liquid level into the foam. The foaming effect is dominant in this phase.

In the second phase, the milk has expanded as it is foamed, thereby the jetstream is at such a depth below the liquid level that the jetstream is not able to draw air from above the liquid level into the foam. The mixing effect is predominant in this phase.

When frothing milk, the foaming of the milk has to be done below 40 degrees as above 40 degrees an inferior foam is produced. An accurate balance has to be struck to have the milk foamed before the milk reaches 40 degrees heated by the steam expelled from the outlet.

According to another aspect of the invention an assembly comprising a receptacle and an auxiliary device for frothing according to any of the preceding embodiments. The device may be advantageously adapted to the receptacle to prevent configuring the device before frothing, thereby shortening the training period.

In an embodiment of the assembly, the device is integrated in the receptacle. This embodiment provides the further advantage of easing the frothing by the operator, thereby further shortening the training period.

In an embodiment of the assembly, the receptacle comprises a side wall, wherein at least a part of the side wall is transparent. When pouring the liquid in the receptacle, the liquid level is hard to estimate. Having at least a part of the side wall transparent allows the operator to view the liquid level from the side, providing a simplified and more accurate method of estimating the liquid level. In a further embodiment of the assembly, the guide has a level indicator. The combination of features of having at least a part of the side wall transparent and a level indicator on the guide provides the advantage for the operator to pour milk with a side view on the indicator combined with the further advantage that the level indicator provides a direct indication of the depth of the outlet relative to the liquid level. In another embodiment of the assembly, the receptacle comprises a level indicator for indicating a preferred level of the liquid in the receptacle. The level indicator may comprise an indication line on, in and/or next to the transparent part of the side wall.

In another embodiment of the assembly, the guide is adjustable in depth and the receptacle comprises a side wall, wherein at least a part of the side wall is transparent. Having at least a part of the side wall transparent allows the operator to view the liquid level from the side, providing a simplified and more accurate method of estimating the liquid level and adjusting the guide for positioning the outlet at a desired depth relative to the liquid level.

In a further embodiment of the assembly, the guide has a level indicator. The combination of features of having at least a part of the side wall transparent, the adjustable guide and a level indicator on the guide provides the advantage for the operator to pour milk with a side view on the indicator combined with the further advantage that the level indicator provides a direct indication of the depth of the outlet relative to the liquid level. With the further effect, that the amount of liquid added by the operator to the receptacle is less critical, because the guide, and thus the outlet, is positionable depending on the liquid level in the receptacle. This provides the advantage of faster loading of the receptacle, while still positioning the outlet for obtaining a frothed liquid.

In a further embodiment of the assembly, the receptacle comprises a side wall, wherein at least a part of the side wall is transparent and the receptacle further comprises two level indications arranged to the transparent part, indicating a maximum and minimum filling level for the liquid. This allows the liquid to be loaded with some margin, providing the advantage of faster loading the receptacle with a liquid. In this embodiment, the guide of the device is adjustable at least over a range equal to the minimum and maximum filling levels for frothing the liquid.

In an embodiment of the assembly, the receptacle comprises a rim forming an opening for receiving the fluid inside the receptacle, wherein the rim comprises a recess for receiving the support. The recess in the rim has the effect that, if the receptacle is placed on a horizontal surface, the maximum volume of liquid held by the receptacle is lowered. This feature may be seen as that the receptacle provides an implicit level indicator for the milk, wherein the liquid is poured into the receptacle where after the device is positioned on the receptacle. Thereby providing the advantage of aiding the pouring of milk and shortening the training period. This feature may also be seen as that the receptacle forces the operator to position the device on the receptacle before frothing, because otherwise the receptacle is not able to hold an adequate amount of liquid for frothing. Thereby providing the advantage that the operator does not forget to position the device, helping and thus shortening the training period. In a further embodiment of the assembly, the device comprises a handled for, when placed on the receptacle, lift or handle the assembly. This handle may then be seen as the removable handle of the receptacle integrated with the device. According to another aspect a method for frothing a liquid, the method comprising the steps of: positioning an auxiliary device according to any of the preceding embodiments on the receptacle; positioning the outlet at an angle and/or at a depth inside the receptacle relative to the support with the guidance of the guide; filling the receptacle with a liquid; and frothing the liquid by expelling a fluid via the outlet such that a jetstream is created.

### BRIEF DESCRIPTION OF THE DRAWINGS

The invention will be apparent from and elucidated further with reference to the embodiments described by way of example in the following description and with reference to the accompanying drawings, in which

FIG. 1 schematically shows a side view of an embodiment of an auxiliary device for frothing a liquid.

FIG. 2 schematically shows a side view of an embodiment of an auxiliary device for frothing a liquid.

FIG. 3 schematically shows a bottom view of an embodiment of an auxiliary device for frothing a liquid.

FIG. 4 schematically shows a cross-section of an embodiment of an auxiliary device for frothing a liquid along the line IV in FIG. 2.

FIG. 5 schematically shows a perspective view of an embodiment of an auxiliary device for frothing a liquid.

FIG. 6 schematically shows a side view of an assembly for frothing a liquid.

The figures are purely diagrammatic and not drawn to scale. In the figures, elements which correspond to elements already described may have the same reference numerals.

LIST OF REFERENCE NUMERALS

| | |
|---|---|
| 1 | auxiliary device |
| 2 | support |
| 3 | guide |
| 4 | releasable connected |
| 10 | longitudinal axis of guide |
| 11 | axis perpendicular to support, axis A |
| 12 | first angle |
| 15 | level indicative support positioned on receptacle |
| 16 | level indicative of position of outlet |
| 17 | depth |
| 18 | second angle |
| 20 | coupling |
| 21 | recess |
| 22 | first wall |
| 23 | second wall |
| 24 | arc shape first wall |
| 25 | arc shape second wall |
| 26 | resilient wall |
| 27 | ‘U’ shape |
| 28 | recess bottom |
| 29 | plane B |
| 30 | hollow elongated body |
| 31 | aperture |
| 32 | abutment |
| 34 | level indicator |
| 40 | temperature indicator |
| 50 | assembly |
| 60 | receptacle |
| 61 | side wall |
| 62 | transparent part of side wall |
| 63 | rim |
| 64 | opening |
| 65 | recess in rim |
| 66 | liquid level |
| 67 | protrusion |
| 68 | resilient clip |

### DETAILED DESCRIPTION OF EXEMPLARY EMBODIMENTS

The following figures may detail different embodiments.

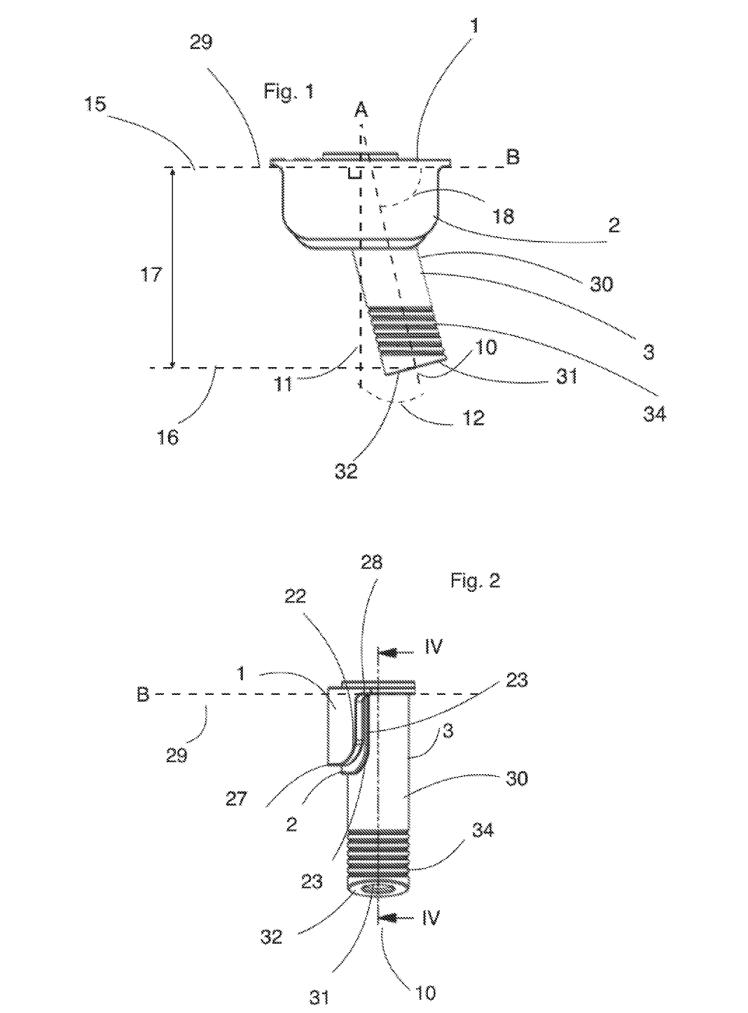

FIG. 1 schematically shows a side view of an embodiment of an auxiliary device 1 for frothing a liquid. The device comprises a support 2 for positioning the device on a receptacle holding the liquid. When the support is positioned on the receptacle, this may be indicated by a first level 15. Typically, the receptacle comprises a rim, defining an opening for receiving the liquid, where upon the support is placed. The first level thereby defines the level of the rim. Further, the opening of the receptacle defines a plane B 29. This plane B may also be defined by a plane comprising all points where a rim of a receptacle contacts the support. An axis A 11 is defined perpendicular to this plane B.

The device further comprises a guide 3 for positioning an outlet for expelling a fluid for frothing the liquid. The guide may comprise an elongated body 30, such as a hollow elongated body, for receiving the outlet expelling the fluid. The outlet typically may be one end of a conduit, which conduit may be part of an apparatus preparing the fluid. The conduit is receivable inside the hollow elongated body. The hollow elongated body may comprise an abutment 32 for abutting the conduit receivable within the body. The abutment preferably defines an aperture 31 for letting the expelled fluid of the outlet through the aperture.

Typically, the aperture has a sharp edge. The sharp edge allows the outlet expelling the fluid to be positioned as close as possible to the outer surface of the auxiliary device. This provides the advantage of minimizing the depth variation for different shaped outlets of steam pipes. Further, this provides the advantage of optimizing the drawing of air along the guide for optimizing the frothing. The guide has a longitudinal axis 10, which normally defines the flow direction of the fluid expelled from the outlet. The outlet may be extended by an extension conduit being part of the guide. This extension conduit may influence the direction and position of where the fluid is expelled into the receptacle and thus the liquid. In this embodiment, it is an outlet of the extension conduit that should be taken as reference for expelling the fluid in the liquid. Further, typically, the receptacle will be held horizontal during frothing. Thus, when the longitudinal axis defines the direction of the expelled fluid, a first angle 12 between the longitudinal axis and the axis A defines an angle of the expelled fluid relative to axis A. A second angle 18 between the level, such as the liquid level in the receptacle, and the direction of the expelled fluid is 90 degrees minus the first angle. The second angle is typically equal to the angle between the expelled fluid and the liquid level.

The outlet comprises at least one opening for expelling the fluid. The outlet may comprise multiple openings, such as 2, 3, 4 or 5 openings. In a further embodiment of the outlet with multiple openings the openings direct the expelled liquid in different directions, which directions may make an angle in the range of 0.5 to 60 degrees. The number of openings and the direction wherein the openings expel the fluid relative to each other may influence the settings of the angle and the depth of the auxiliary device.

The guide positions the outlet at a certain level 16. The distance between the level when the support is positioned and the level of the outlet defines a depth 17 of the position of where the fluid is expelled in the receptacle relative to the rim of the receptacle, when the device is placed on the receptacle. Further, the receptacle is filled with a liquid to a predefined level and held horizontal during frothing. Thus, the depth indirectly defines a depth of the outlet relative to the liquid level.

The guide may further comprise a level indicator 34, preferably multiple level indicators 34. The level indicator indicates to which level the receptacle should be filled with liquid, when the device is placed upon the receptacle. The level indicator allows the depth of the outlet relative to the liquid level to be defined directly.

FIG. 2 schematically shows a side view of an embodiment of an auxiliary device for frothing a liquid. The side view of FIG. 2 is a ninety-degree clockwise rotation of FIG. 1 along the axis A seen from above. Although FIG. 2 shows longitudinal axis A perpendicular to plane B, in a preferred embodiment the axis is not perpendicular to plane B. This has the effect of disrupting the cylindrically shaped swirl in the receptacle, thereby improving mixing of the liquid and the fluid.

The support may further comprise a first wall 22, a second wall 23 and a bottom 28 forming a recess 21. The recess may have the cross sectional shape 27 of a ‘U’. The recess is an embodiment of a coupling 20 for coupling with the side wall of a receptacle, wherein at least the recess bottom contacts the rim of the side wall.

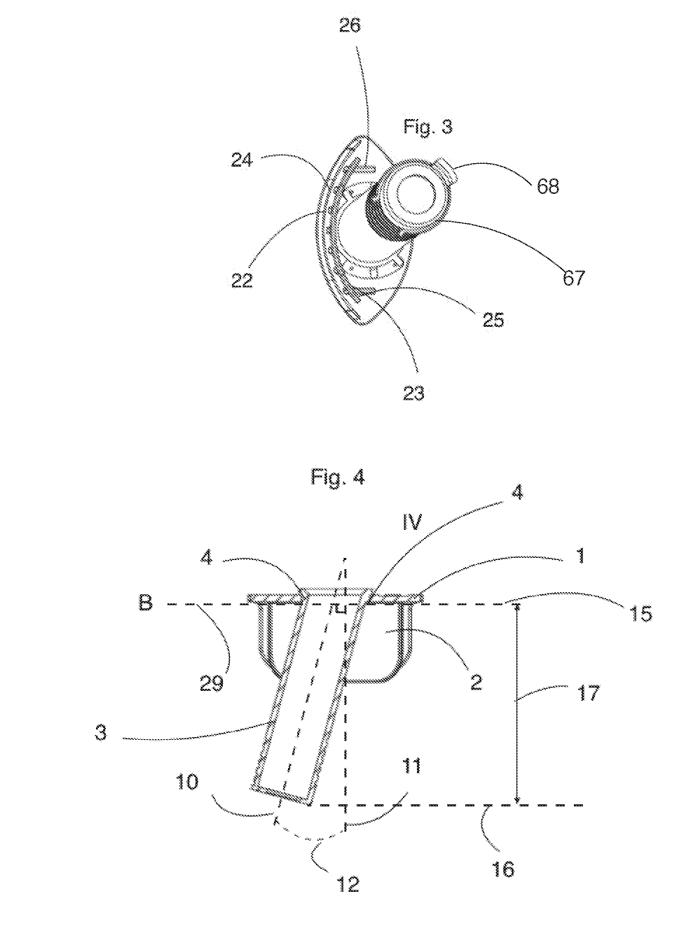

FIG. 3 schematically shows a bottom view of an embodiment of an auxiliary device for frothing a liquid. The first wall 22 has a first arc shape 24 and the second wall 23 has a second arc shape 25. The arc shapes are substantially the same as an arc shape of the side wall of the receptacle where upon the device is to be placed. Having a slightly different arc shape from the side wall of the receptacle may provide a releasable coupling between the support and the receptacle.

The arc shapes of the first and second wall may differ to provide a recess with varying width. The recess of varying width has the advantage of providing a clamping effect at narrow width points and providing low friction on wide width points of the recess.

Furthermore, the first and/or second wall may be made a resilient wall 26 for providing more flexibility of adapting the recess to and/or clamping the recess upon the side wall of different receptacles, wherein the arc shape and/or thickness of side wall varies.

Optionally, one of the level indicators 34, embodied as grooves, holds a resilient clip 68. In a further embodiment of the clip, the clip comprises a protrusion 67.

FIG. 4 schematically shows a cross-section of an embodiment of an auxiliary device for frothing a liquid along the line IV in FIG. 2. The device may comprise a support 2 and a guide 3, which are releasable connected 4. The guide comprises a wedge shape on one end. The support comprises an opening. And when connected, the one end of the guide is wedged into the opening for providing a stable connection. The guide may comprise a lip and the opening may comprise a recess for receiving the lip when connected for predefining the angle of rotation and/or position of the guide relative to the support, thereby influencing the angle and/or depth of the outlet.

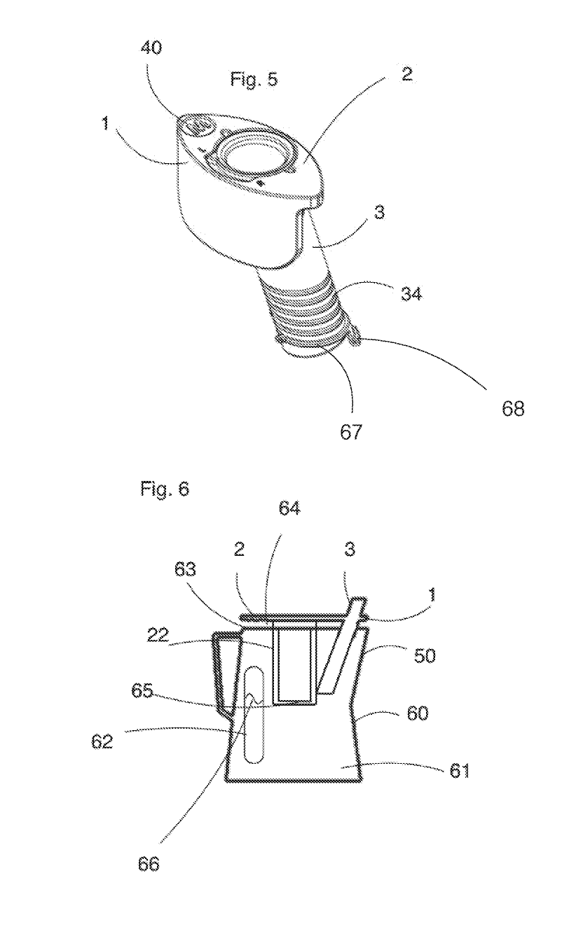

FIG. 5 schematically shows a perspective view of an embodiment of an auxiliary device for frothing a liquid. The device, such as the support, may comprise a temperature indicator 40. The temperature indicator may be a fluid based thermometer. Alternatively, the temperature indicator may comprise thermochromic pigment. If the support comprises thermochromic pigment, the pigment needs to be thermally coupled to the liquid or the foam in the receptacle. This coupling may comprise thermally conductive material, such as a metal rod along or integrated with the guide.

In an embodiment, the auxiliary device has a guide shaped as a pipe acting as a sleeve over a steam pipe, when positioned in the auxiliary device. Typically, the aperture of the guide forms an air-tight sealing preventing air to be sucked in between the guide and the steam pipe preventing additional air to be mixed into the liquid. The operator thereby controls the amount air added by positioning the outlet at an angle and/or a depth inside the receptacle relative to the support. By controlling the amount of air, the operator is able to control the thickness of the foam. In an alternative embodiment, the guide may comprise a resilient ring, such as a rubber ring, arranged concentric around the aperture to form the sealing.

FIG. 6 schematically shows a side view of an assembly 50 for frothing a liquid. The assembly comprises an auxiliary device 1 and a receptacle 60. The device 1 comprises a support 2 and a guide 3.

The receptacle comprises a side wall 61. The side wall may be substantially cylindrically shaped. Alternatively, the side wall may be substantially conically shaped, such as a truncated conical shape. The side wall provides a rim 63 forming an opening 64 for receiving the liquid.

The receptacle may comprise a part 62 of the side wall, which is transparent. The shape of this transparent part may have any shape as long as it at least provides a view at the liquid level 66. Alternatively, the side wall as a whole may be transparent.

In an alternative embodiment of the device the support may cover or substantially cover the opening of a receptacle. The support may have the shape of a cap covering the opening of a receptacle. In an alternative embodiment, the support comprises a cap and a pedestal on a side, such as a bottom side, of the cap for fitting the pedestal inside an opening of a receptacle, wherein the cap and pedestal form the coupling.

In an alternative embodiment of the assembly, the rim 63 of the receptacle 60 comprises a recess 65 and the support 2 is shaped for the support to form a liquid and/or foam proof seal with the side wall.

In the foregoing specification, the invention has been described with reference to specific examples of embodiments of the invention. It will, however, be evident that various modifications and changes may be made therein without departing from the scope of the invention as set forth in the appended claims. For example, the shapes may be any type of shape suitable to achieve the desired effect. Devices functionally forming separate devices may be integrated in a single physical device.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ or ‘including’ does not exclude the presence of other elements or steps than those listed in a claim. Furthermore, the terms “a” or “an,” as used herein, are defined as one or as more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An auxiliary device for frothing a liquid in a receptacle, comprising:
a support for positioning the device on the receptacle holding the liquid; and
a guide for positioning an outlet for expelling a fluid for frothing the liquid, wherein the guide is adapted for positioning the outlet at an angle inside the receptacle relative to the support for letting the fluid create a jetstream in the liquid.

2. A device according to claim 1, wherein the angle is in the range of 55-89 degrees.

3. A device according to claim 1, wherein the support comprises a coupling for releasable coupling to the receptacle.

4. A device according to claim 1, wherein the support comprises a recess for receiving a part of the receptacle for positioning the device.

5. A device according to claim 4, wherein the recess comprises two walls having an arced shape having distinct centres and wherein at least one of the walls is resilient, for forming a coupling for releasable coupling to the receptacle.

6. A device according to claim 4, wherein the recess has a cross sectional shape of a ‘U’, wherein one leg of the ‘U’ is longer relative to the other leg.

7. A device according to claim 1, wherein the guide has a hollow elongated body comprising an abutment on one end for receiving the outlet in the body and for abutting the outlet on the abutment for positioning the outlet at the angle relative to the flow direction inside the receptacle relative to the support.

8. A device according to claim 1, wherein the guide has a level indicator for indicating a preferred filling level of the fluid.

9. A device according to claim 1, wherein the support and the guide are releasably connectable.

10. A device according to claim 1, comprising a temperature indicator for indicating a temperature inside the receptacle of the liquid or the frothed liquid.

11. A device according to claim 1, wherein the liquid is a liquid containing protein, such as milk, and the expelled fluid is steam.

12. An assembly comprising:
a receptacle and
an auxiliary device for frothing a liquid in the receptacle, the device comprising
a support for positioning the device on the receptacle holding the liquid; and
a guide for positioning an outlet for expelling a fluid for frothing the liquid, wherein the guide is adapted for positioning the outlet at an angle inside the receptacle relative to the support for letting the fluid create a jetstream in the liquid.

13. An assembly according to claim 12, wherein the receptacle comprises a side wall, wherein at least a part of the side wall is transparent.

14. An assembly according to claim 12, wherein the receptacle comprises a rim forming an opening for receiving the fluid inside the receptacle, wherein the rim comprises a recess for receiving the support.

15. A method for frothing a liquid, the method comprising the steps of:
positioning an auxiliary device on the receptacle wherein the device comprises
a support for positioning the device on the receptacle; and
a guide for positioning an outlet for expelling a fluid for frothing the liquid, wherein the guide is adapted for positioning the outlet at an angle inside the receptacle relative to the support for letting the fluid create a jetstream in the liquid;
positioning the outlet at an angle inside the receptacle relative to the support with the guidance of the guide;
filling the receptacle with a liquid; and
frothing the liquid by expelling a fluid via the outlet such that a jetstream is created.

16. A device according to claim 1, wherein the guide is further adapted for positioning the outlet at a depth inside the receptacle relative to the support for letting the fluid create a jetstream in the liquid.

17. A device according to claim 2, wherein the angle is in the range of 65-85 degrees.

18. A device according to claim 9, wherein the support and the guide are releasably connectable under different angles and at different distances.
